(19) United States
(12) Patent Application Publication
(10) Pub. No.: US 2014/0313414 A1
(43) Pub. Date: Oct. 23, 2014

(54) SMARTPHONE

(71) Applicant: Pao-Tse WU, Taipei City (TW)

(72) Inventor: Pao-Tse WU, Taipei City (TW)

(73) Assignee: Jane-Yuan Li, Taipei City (TW)

(21) Appl. No.: 13/867,296

(22) Filed: Apr. 22, 2013

(51) Int. Cl. H04N 5/44; H04N 21/41

(52) U.S. Cl. CPC H04N 5/4403; H04N 21/4126
USPC 348/552

(57) ABSTRACT

A smartphone characterized in that: an application processor enables a first user interface to be sent and displayed on a touch screen of the smartphone if a smartphone is not electrically connected to an external display or a flat-screen TV set and a displaying criterion of the touch screen is met, wherein the first user interface comprises at least a mobile phone application; and the application processor sends a second user interface to the external display or the flat-screen TV set if the smartphone is electrically connected to the external display or the flat-screen TV set and a displaying criterion of the external display or the flat-screen TV set is met, wherein the second user interface comprises at least an application for use in operating the external display or the flat-screen TV set. The application processor sends commands and/or data to the external display or the flat-screen TV set.

### FIELD OF THE INVENTION

The present invention relates to portable electronic equipment, and more particularly, to a smartphone.

### BACKGROUND OF THE INVENTION

U.S. Pat. No. 8,082,523B2. entitled Portable Electronic Device With Graphic User Interface Supporting Application Switching, discloses a graphic user interface (UI) for use with a mobile phone.

U.S. Pat. No. 7,509,588B2, entitled Portable Electronic Device With Interface Reconfiguration Mode. discloses an interface reconfiguration mode in which a plurality of icons is displayed on a touch screen of a portable electronic device so as to change initial positions of the displayed icons and then reconfigure them.

However, according to the aforesaid prior arts, an UI is still confined to a built-in touch screen of a portable electronic device for performing UI configuration or reconfiguration.

In view of the aforesaid drawbacks of the prior arts. the inventor of the present invention conceived room for improvement in the prior art and thus developed a smartphone that provide UIs to a screen characterized by two different display requirements.

### SUMMARY OF THE INVENTION

An objective of the present invention is to provide a smartphone capable of providing a first user interface and a second user interface and choosing therebetween.

In order to achieve the above and other objectives, the present invention provides a smartphone comprising an application processor, a touch screen, a communication connector, and a video port connector and is characterized in that: an application processor enables a first user interface to be sent and displayed on a touch screen of the smartphone if a smartphone is not electrically connected to an external display or a flat-screen TV set and the displaying criteria of displaying area and resolution of the touch screen are met, wherein the first user interface comprises at least a mobile phone application (App): and the application processor sends a second user interface to the external display or the flat-screen TV set if the smartphone is electrically connected to the external display or the flat-screen TV set and the displaying criteria of screen displaying area and screen resolution of the external display or the flat-screen TV set are met, wherein the second user interface comprises at least an application (App) for use in operating the external display or the flat-screen TV set. The communication connector is electrically connected to the external display or the flat-screen TV set, wherein the application processor sends commands and/or data to the external display or the flat-screen TV set by means of the communication connector. The video port connector is electrically connected to the external display or the flat-screen TV set and adapted to send video signals corresponding to the second user interface.

The present invention further provides a smartphone comprising an application processor, a touch screen and is characterized in that: a user human-machine interface (UI) switching unit generates a user human-machine interface (UI) switching signal; the application processor receives the UI switching signal during a boot-up process and chooses between a first user interface and a second user interface according to the UI switching signal; after choosing the first user interface, the application processor enables the first user interface to be sent and displayed on the touch screen if displaying criteria of displaying area and resolution of the touch screen are met, wherein the first user interface comprises at least a mobile phone application (App); and after choosing the second user interface, the application processor sends the second user interface to the external display or the flat-screen TV set if displaying criteria of screen displaying area and screen resolution of an external display or a flat-screen TV set are met.

### BRIEF DESCRIPTION OF THE DRAWINGS

Technical features and advantages of the present invention are hereunder illustrated with preferred embodiments in conjunction with the accompanying drawings, in which:

FIG. 1 is a block diagram of a smartphone according to a specific embodiment of the present invention;

FIG. 2A is a schematic view of the smartphone electrically connected to an external display according to the present invention;

FIG. 2B is a schematic view of the smartphone electrically connected to a flat-screen TV set according to the present invention;

FIG. 3 is an exemplary schematic view of a first user interface of the smartphone according to the present invention;

FIG. 4 is an exemplary schematic view of a second user interface of the smartphone according to the present invention;

FIG. 5 is a flow chart of a process whereby the smartphone chooses between the first user interface and the second user interface according to whether the smartphone is electrically connected to the external display or the flat-screen TV set according to the present invention;

FIG. 6 is a schematic view of an operation state of the smartphone and the flat-screen TV set which are connected together according to the present invention; and

FIG. 7 is a flow chart of a process whereby the smartphone chooses between the first user interface and the second user interface according to a user human-machine interface switching signal according to the present invention.

### DETAILED DESCRIPTION OF THE EMBODIMENTS

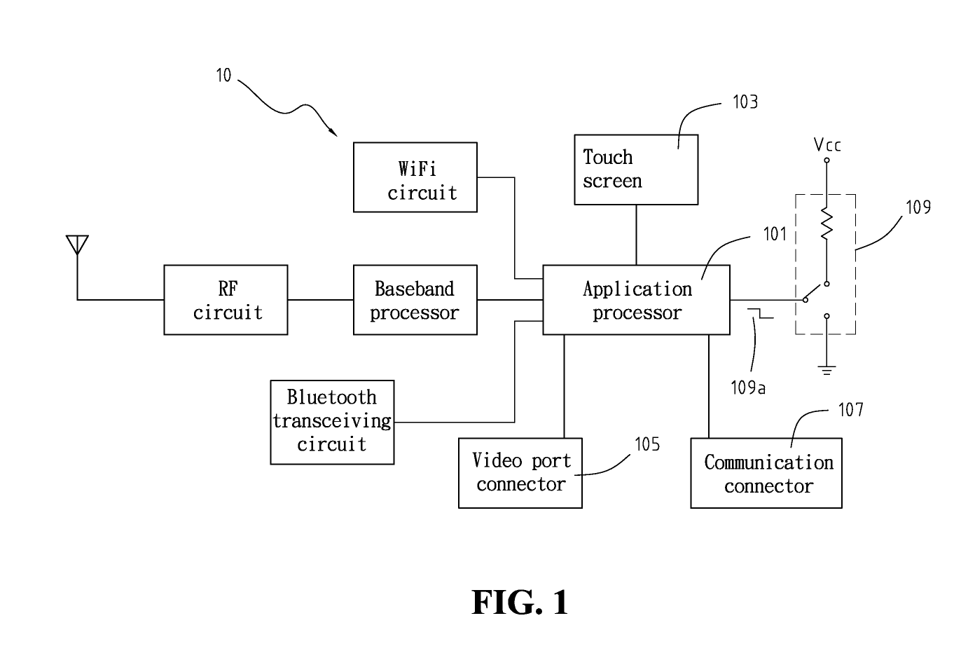

Referring to FIGS. 1, 2A, 2B, 6, a smartphone 10 of the present invention can be connected to an external display 21 or a flat-screen TV set 23 such that an application processor 101 of the smartphone 10 not only sends video signals but also sends signals of commands and/or data 100 to the external display 21 or the flat-screen TV set 23.

Referring to FIG. 1, the smartphone 10 essentially comprises the application processor 101, a touch screen 103, a video port connector 105, a communication connector 107, a baseband processor, a RF circuit, a WiFi circuit, and a Bluetooth transceiving circuit. FIG. 1 shows major hardware components of the smartphone 10, wherein the major hardware components relate to the present invention; however, FIG. 1 omits the other components of the smartphone 10, wherein the other components do not relate to the present invention directly.

Referring to FIG. 1, the baseband processor and the RF circuit are hardware components indispensable to the process of executing a mobile phone application (App) by the smartphone 10. The smartphone 10 further comprises the WiFi circuit for effectuating a wireless connection to the Internet or a local area network (LAN).

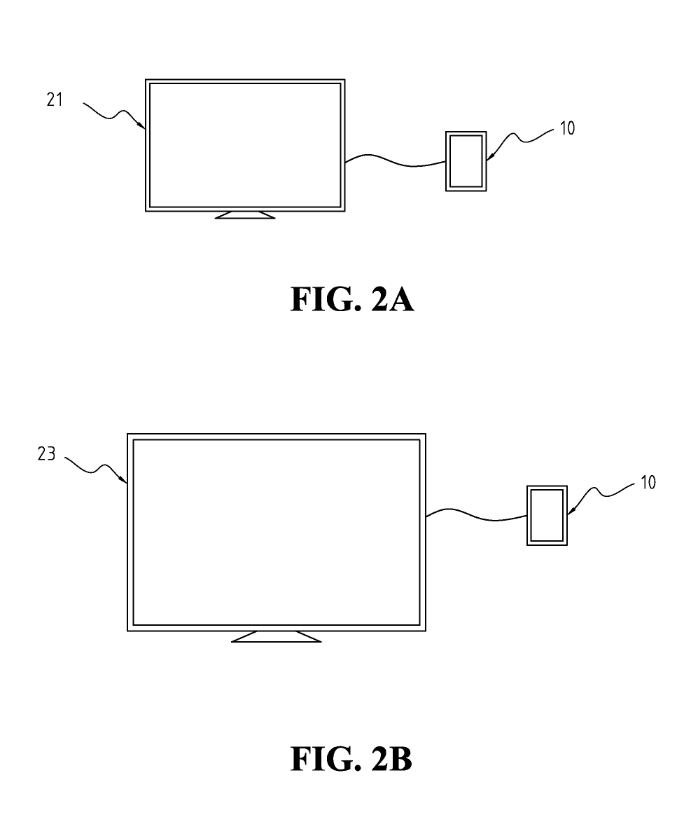

Referring to FIG. 2A, the external display 21 is equipped with a video port connector (not shown) corresponding to the video port connector 105, and is equipped with a communication connector (not shown) corresponding to the communication connector 107. The other hardware components of the external display 21 are identical to their counterparts of a conventional display according to the prior art. Referring to FIG. 2B, the flat-screen TV set 23 is equipped with a video port connector (not shown) corresponding to the video port connector 105, and is equipped with a communication connector (not shown) corresponding to the communication connector 107. The other hardware components of the flat-screen TV set 23 are governed by display-related prior art pertaining to conventional flat-screen TV sets. The screen of the external display 21 and the screen of the flat-screen TV set 23 are a conventional liquid crystal screen, a conventional plasma screen, a conventional organic light-emitting diode (OLED) screen, or a conventional active-matrix organic light-emitting diode (AMOLED) screen.

Persons skilled in the art know that the screen of the touch screen 103 built in the smartphone 10 is much smaller than the screen of the external display 21 or the screen of the flat-screen TV set 23. Hence, according to the present invention, it is likely that user a human-machine interface (UI) operation will be inconvenient to users, if the screen of the external display 21 or the screen of the flat-screen TV set 23 employs a user interface UI of the touch screen 103 of the smartphone 10 indiscriminately.

In another aspect, if a user wants to connect the smartphone 10 and the external display 21 or the flat-screen TV set 23 together, the present invention can allow the user to enjoy the UI-based experience of operating the screen of the external display 21 or the screen of the flat-screen TV set 23 in the same way of enjoying the UI-based experience of operating a smart TV set.

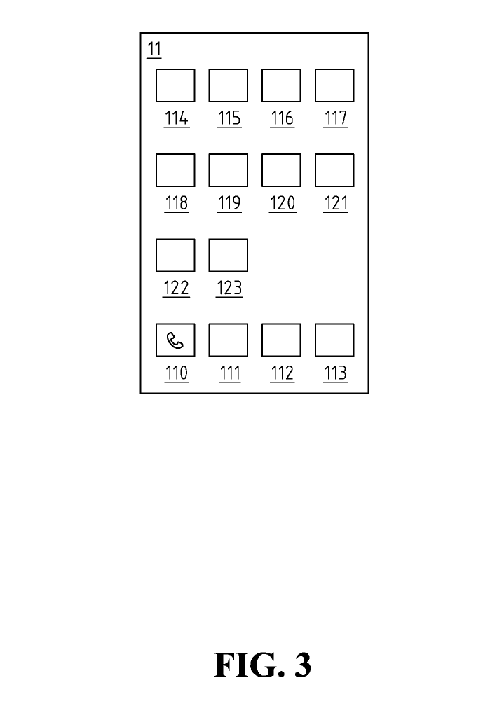

Referring to FIG. 3, there is shown an exemplary schematic view of a first user interface (UI) 11 of the smartphone according to the present invention. The first user interface 11 is displayed on the touch screen 103 built in the smartphone 10. The features of the first user interface 11 are designed to meet the displaying criteria of displaying area and resolution of the touch screen 103. The first user interface 11 comprises at least a mobile phone application (App) 110. The mobile phone application 110 is associated with the aforesaid baseband processor and the aforesaid RF circuit. In a specific embodiment of the present invention, for example, the purpose of the mobile phone application 110 is to serve as a phone-calling application. The displaying criteria for the touch screen 103 include the displaying area and resolution. The displaying area of the touch screen 103 is less than the displaying area of a conventional five-inch touch screen. Alternatively, the displaying area of the touch screen 103 is equal to or slightly larger than the displaying area of a conventional five-inch touch screen. For example, the resolution of the touch screen 103 equals 1280×720. or equals the resolution of WXGA screen, the resolution of XGA screen, the resolution of WVGA screen, or the resolution of HVGA screen.

Referring to FIG. 3, for example, applications 111-123 of the first user interface 11 on the touch screen 103 are of a configuration characterized by a maximum of four applications horizontally and a maximum of four applications vertically. The aforesaid configuration is implemented according to a displaying criterion of the touch screen 103. Of course, the disclosed UI design of conventional Android smartphones or Apple's conventional iPhone can be regarded as a reference for the configuration of the first user interface 11 of the present invention.

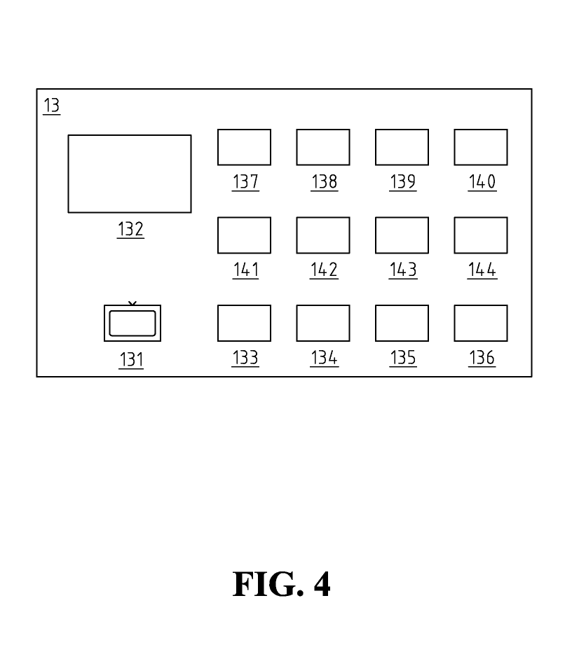

Referring to FIG. 4, there is shown an exemplary schematic view of a second user interface (UI) of the smartphone according to the present invention. The second user interface 13 is sent to the external display 21 or the flat-screen TV set 23 and then displayed on the screen of the external display 21 or the screen of the flat-screen TV set 23. The features of the second user interface 13 are designed to meet the displaying criteria of screen displaying area and screen resolution of the external display 21 or the flat-screen TV set 23. The displaying criteria of the external display 21 or the flat-screen TV set 23 include screen displaying area and screen resolution. For example, the displaying area of the screen of the external display 21 is less than the displaying area of a conventional 27-inch wide screen. Alternatively, the displaying area of the screen of the external display 21 is equal to or slightly larger than the displaying area of a conventional 27-inch wide screen. For example, the screen resolution of the external display 21 is equal to or larger than 1290×1080. For example, the displaying area of the screen of the flat-screen TV set 23 is no less than the displaying area of a conventional 32-inch wide screen. For example, the screen resolution of the flat-screen TV set 23 is equal to or larger than 1290×1080.

Referring to FIG. 4, the configuration of applications 131, 133-144 of the second user interface 13 is implemented according to a displaying criterion of the external display 21 or the flat-screen TV set 23. Of course, the disclosed UI design of conventional Android smart TV sets, conventional Android smart TV set-top boxes, or Apple's conventional Apple TV set-top boxes can be regarded as a reference for the configuration of the second user interface 13 of the present invention.

Referring to FIG. 4, a user interface 132 of the second user interface 13 has a small display region. The small display region is reserved for use by the flat-screen TV set 23 in displaying a currently-watched TV program, such that a TV program currently selected and watched at a TV channel, at a screen location corresponding to the small display region. To this end, the flat-screen TV set 23 has to be capable of Picture-in-Picture (PiP).

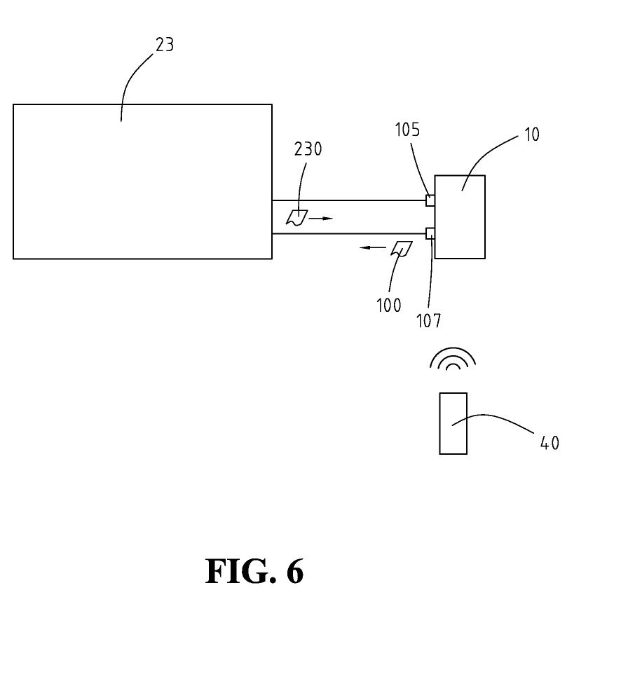

The application 131 is for use in operating the external display 21 or the flat-screen TV set 23. The user can execute the application 131, for example, for giving commands to the external display 21 to shut down the screen (power), start the screen (power), or switch between signal sources, or, for example, for giving commands to the flat-screen TV set 23 to shut down the screen (power), start the screen (power), switch between signal sources, select TV channels, tune volume, or display an electronic program guide (EPG). The packet dedicated to the command and/or data 100 is sent to the external display 21 or the flat-screen TV set 23 by means of the communication connector 107, as shown in FIG. 6.

According to the spirit of the disclosure contained in the present invention, persons skilled in the art can enhance the communication functions and processing capability of the external display 21 or the flat-screen TV set 23, such that the external display 21 or the flat-screen TV set 23 is equipped with: the communication capability required for receiving the command and/or data 100; and the processing capability of a processor (not shown) or a system-on-chip (SoC) (not shown) for use with the external display 21 or the flat-screen TV set 23 in processing the command and/or data 100.

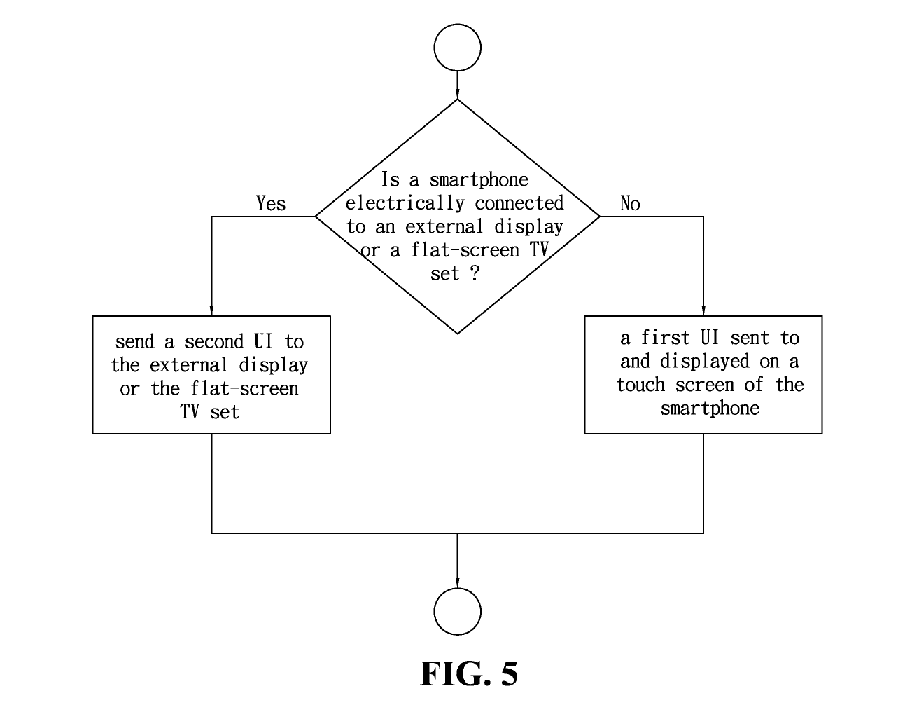

Referring to FIG. 5, in an embodiment of the present invention, the application processor 101 enables the first user interface 11 to be sent and displayed on the touch screen 103 if smartphone 10 is not electrically connected to the external display 21 or the flat-screen TV set 23; meanwhile, the user touches the first user interface 11 displayed on the touch screen 103 in order to operate the smartphone 10.

Referring to FIGS. 5, 6, the application processor 101 sends the second user interface 13 to the external display 21 or the flat-screen TV set 23 if the smartphone 10 is electrically connected to the external display 21 or the flat-screen TV set 23 as shown in FIG. 2A and FIG. 2B. Take as an example the situation where the smartphone 10 is electrically connected to the flat-screen TV set 23 to explain how the user makes use of the second user interface 13. The user selects and/or executes the applications 131, 133-144 of the second user interface 13 by means of a wireless user interface (UI) input device 40. In a specific embodiment of the present invention, for example, the wireless UI input device 40 is a conventional Bluetooth touch panel, a conventional Bluetooth mouse, a conventional Bluetooth keyboard, or any other conventional Bluetooth input device. A wireless signal of the aforesaid conventional Bluetooth input device is received by a Bluetooth transceiving circuit (as shown in FIG. 1) of the smartphone 10. In another specific embodiment of the present invention, for example, the wireless UI input device 40 is a conventional wireless touch panel, a conventional wireless mouse, a conventional wireless keyboard, or any other conventional wireless input device. For example, if the user plugs a conventional USB wireless receiver (not shown) into the smartphone 10, the wireless signal of the aforesaid conventional wireless input device can be received by the conventional USB wireless receiver and then processed by the application processor 101.

In yet another specific embodiment of the present invention, for example, the wireless UI input device 40 is a conventional Bluetooth earphone microphone whereby the user selects and/or executes the applications 131, 133-144 of the second user interface 13 by voice.

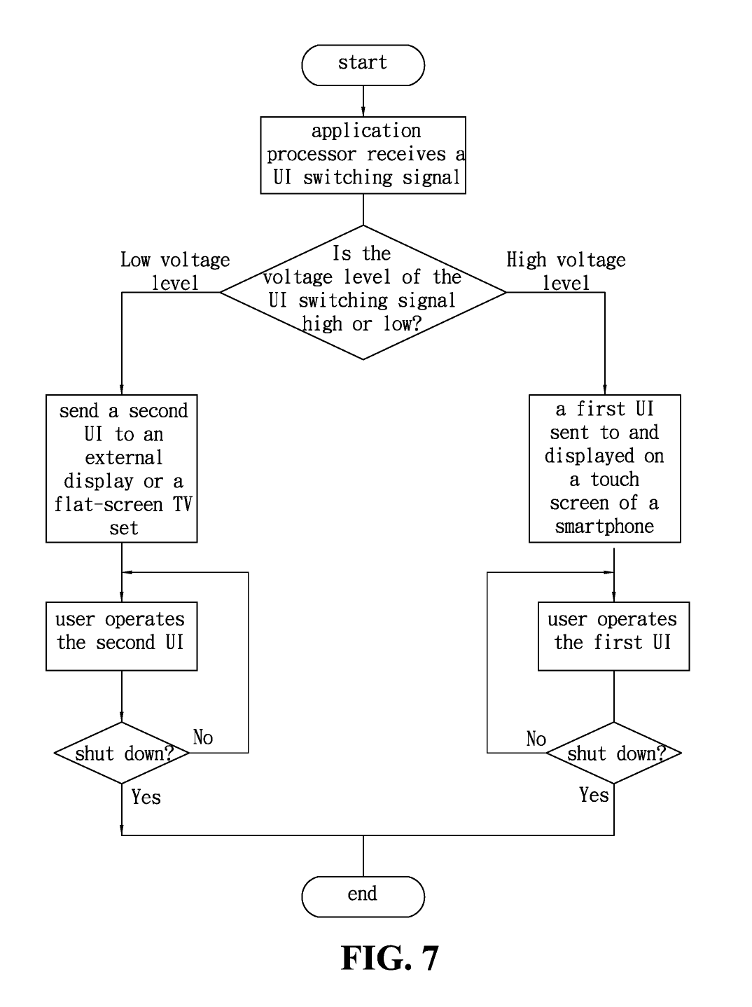

Referring to FIGS. 1, 7, a user human-machine interface (UI) switching unit 109 switches between the first user interface 11 and the second user interface 13. The user human-machine interface (UI) switching unit 109 generates a user human-machine interface (UI) switching signal 109a. The application processor 101 receives the UI switching signal 109a and chooses between the first user interface 11 and the second user interface 13 according to the UI switching signal 109a. In a specific embodiment of the present invention, the UI switching unit 109 comprises a switch. The switch switches between a high voltage level and a low voltage level to thereby generate the UI switching signal 109a of a high voltage level or the UI switching signal 109a of a low voltage level. The switch is disposed on a lateral side of a casing of the smartphone 10 and thus is accessible by users.

To access the first user interface 11, a user operates the aforesaid switch to select a high voltage level, and then the user starts the smartphone 10. During the boot-up process, the application processor 101 receives the UI switching signal 109a, identifies the UI switching signal 109a as a UI switching signal of the high voltage level, and eventually enables the first user interface 11 to be sent and displayed on the touch screen 103. Upon completion of the boot-up process, the user touches the first user interface 11 displayed on the touch screen 103 in order to operate the smartphone 10.

In another aspect, to access the second user interface 13, the user operates the aforesaid switch to select a low voltage level, connects the smartphone 10 to the external display 21 or the flat-screen TV set 23 with at least one cable (such as a USB 3.0 cable or a HDMI cable), and eventually starts the smartphone 10. During the boot-up process, the application processor 101 receives the UI switching signal 109a, identifies the UI switching signal 109a as a UI switching signal of the low voltage level, and eventually enables the second user interface 13 to be sent and displayed on the external display 21 or the flat-screen TV set 23. Upon completion of the boot-up process, the user operates the smartphone 10 by means of the wireless UI input device 40. In particular, the present invention enables the user to enjoy the UI-based experience of operating the screen of the external display 21 or the screen of the flat-screen TV set 23 in the same way of enjoying the UI-based experience of operating a smart TV set.

It is also feasible to implement the UI switching unit 109 by a firmware means. For example, the user sets a flag value by executing a setting application built in the smartphone 10. Afterward, during the boot-up process, the application processor 101 examines the aforesaid flag value for choosing between the first user interface 11 and the second user interface 13. The flag value serves the same purpose as the UI switching signal 109a does, substantially.

The first user interface 11 and the second user interface 13 are stored in a flash memory (not shown) in the smartphone 10. Alternatively, the first user interface 11 is stored in a flash memory (not shown) in the smartphone 10, whereas the second user interface 13 is stored in a memory card (not shown) which is inserted into the smartphone 10, such as a conventional SD memory card.

The first user interface 11 can be a graphic user interface, whereas the second user interface 13 can be a graphic user interface.

According to the spirit of the disclosure contained in the present invention, persons skilled in the art can enhance the communication functions of the external display 21 or the flat-screen TV set 23, such that the external display 21 or the flat-screen TV set 23 acquires the communication capability required for sending commands and/or data 230 to the application processor 101 of the smartphone 10.

The smartphone 10 of the present invention is concurrently equipped with the first user interface 11 and the second user interface 13 so as to function as a smartphone and a simulated smart TV, respectively. Accordingly, the present invention increases the values of conventional smartphones greatly and enhances the functions and advantages thereof notably.

Hence, the present invention meets the three requirements of patentability, namely novelty, non-obviousness, and industrial applicability.

The present invention is disclosed above by preferred embodiments. However, persons skilled in the art should understand that the preferred embodiments are illustrative of the present invention only, but should not be interpreted as restrictive of the scope of the present invention. Hence, all equivalent variations and modifications made to the aforesaid embodiments should fall within the scope of the present invention.

What is claimed is:

1. A smartphone comprising an application processor, a touch screen, a communication connector, and a video port connector and is characterized in that:
the application processor enables a first user interface to be sent and displayed on the touch screen if the smartphone is not electrically connected to an external display or a flat-screen TV set, wherein the first user interface is designed to meet the touch screen, wherein the first user interface comprises at least a mobile phone application (App), and the application processor sends a second user interface to the external display or the flat-screen TV set if the smartphone is electrically connected to the external display or the flat-screen TV set, wherein the second user interface is designed to meet displaying criteria of screen displaying area and screen resolution of the external display or the flat-screen TV set, wherein the second user interface comprises at least an application (App) for use in operating the external display or the flat-screen TV set;
the communication connector is electrically connected to the external display or the flat-screen TV set, wherein the application processor sends commands and/or data to the external display or the flat-screen TV set via the communication connector; and
the video port connector is electrically connected to the external display or the flat-screen TV set and adapted to send video signals corresponding to the second user interface.

2. The smartphone of claim 1, wherein the communication connector is a two-way high-speed communication connector.

3. The smartphone of claim 1, wherein the video port connector is one of a HDMI connector, a DVI connector, and a display port connector.

4. The smartphone of claim 1, wherein the external display or the flat-screen TV set to sends commands and/or data to the application processor of the smartphone via the communication connector.

5. The smartphone of claim 1, wherein a screen of the flat-screen TV set is one of a liquid crystal screen. a plasma screen, an organic light-emitting diode (OLED) screen, and an active-matrix organic light-emitting diode (AMOLED) screen, wherein a screen of the external display is one of a liquid crystal screen, a plasma screen, an organic light-emitting diode (OLED) screen, and an active-matrix organic light-emitting diode (AMOLED) screen.

6. The smartphone of claim 1, wherein the second user interface comprises a plurality of applications (App) associated with a smart TV.

7. The smartphone of claim 1, wherein the second user interface comprises at least a user interface having a small display region, wherein the small display region is reserved for use by the flat-screen TV set in displaying a currently-watched TV program at a screen location corresponding to the small display region.

8. The smartphone of claim 1, wherein the first user interface is a graphic user interface, and the second user interface is a graphic user interface.

9. A smartphone comprising an application processor, a touch screen and is characterized in that:
a user human-machine interface (UI) switching unit generates a user human-machine interface (UI) switching signal;
the application processor receives the UI switching signal during a boot-up process and chooses between a first user interface and a second user interface according to the UI switching signal;
after choosing the first user interface, the application processor enables the first user interface to be sent and displayed on the touch screen, wherein the first user interface is designed to meet displaying criteria of screen displaying area and screen resolution of the touch screen, wherein the first user interface comprises at least a mobile phone application (App); and
after choosing the second user interface, the application processor sends the second user interface to the external display or the flat-screen TV set, wherein the second user interface is designed to meet displaying criteria of screen displaying area and screen resolution of the external display or the flat-screen TV set.

10. The smartphone of claim 9, wherein the second user interface comprises at least an application (App) for use in operating the external display or the flat-screen TV set.

11. The smartphone of claim 9, further comprising a communication connector, wherein the communication connector is electrically connected to the external display or the flat-screen TV set, wherein the application processor sends commands and/or data to the external display or the flat-screen TV set via the communication connector.

12. The smartphone of claim 11, wherein the communication connector is a two-way high-speed communication connector.

13. The smartphone of claim 11, wherein the external display or the flat-screen TV set sends commands and/or data to the application processor of the smartphone via the communication connector.

14. The smartphone of claim 9, wherein a screen of the flat-screen TV set is one of a liquid crystal screen, a plasma screen, an organic light-emitting diode (OLED) screen, and an active-matrix organic light-emitting diode (AMOLED) screen, wherein a screen of the external display is one of a liquid crystal screen, a plasma screen, an organic light-emitting diode (OLED) screen, and an active-matrix organic light-emitting diode (AMOLED) screen.

15. The smartphone of claim 9, wherein the second user interface comprises a plurality of applications (App) associated with a smart TV.

16. The smartphone of claim 9, wherein the second user interface comprises at least a user interface having a small display region, wherein the small display region is reserved for use by the flat-screen TV set in displaying a currently-watched TV program at a screen location corresponding to the small display region.

17. The smartphone of claim 9, wherein the first user interface is a graphic user interface, and the second user interface is a graphic user interface.

18. The smartphone of claim 9, further comprising a video port connector, wherein the video port connector is electrically connected to the external display or the flat-screen TV set and adapted to send video signals corresponding to the second user interface.

19. The smartphone of claim 18, wherein the video port connector is one of a HDMI connector, a DVI connector, and a display port connector.
